(19) United States
(12) Patent Application Publication
(10) Pub. No.: US 2011/0041396 A1
(43) Pub. Date: Feb. 24, 2011

(54) Convex Cutting and Trimming Method for Shaping Trees

(76) Inventor: Robert N. Stafford, Alexandria, IN (US)

Correspondence Address: RITCHISON LAW OFFICES, PC, 115 EAST NINTH STREET - SUITE A, ANDERSON, IN, 46016-1507, US

(21) Appl. No.: 12/859,237

(22) Filed: Aug. 18, 2010

Related U.S. Application Data
(60) Provisional application No. 61/235,026, filed on Aug. 19, 2009.

(51) Int. Cl. A01G 1/00; A01G 3/00

(52) U.S. Cl. 47/8; 144/363

(57) ABSTRACT

A tree trimming method that is related to a convex method of angular trimming of trees. The methodology uses angle cuts for tree trimming and shaping of all shade trees, evergreen trees, and ornamental trees. The angle cutting of limbs is in a “convex cut”. This makes curved cuts bring the tree limbs in a radial shape and encourages them to grow which results in the tree canopy to be round or radial in shape. Angle cutting proves useful either on the outside perimeter or useful in vertical clearing inside the tree canopy for clearance (for power lines and such). Essentially any angle of clearing or directional shaping can be done with this of cutting method—under the canopy, on the sides, at the top, or clearing pathways through the middle without damage to the trees.

### CROSS-REFERENCE TO RELATED APPLICATIONS

This application claims the benefit of Provisional Patent Application Ser. No. 61/235,026 filed Aug. 19, 2009 by Robert N. Stafford and entitled “Convex Cutting and Trimming Method for Shaping Trees”.

### FIELD OF INVENTION

A tree trimming method described within is related to a convex method of angular trimming of trees. The methodology uses angle cuts for tree trimming and shaping of all shade trees, evergreen trees, and ornamental trees. The angle cutting of limbs in a “convex cut”. This makes curved cuts bring the tree limbs (i.e. encourage them to grow) in a radial shape, resulting in the tree canopy to be round or radial in shape. Angle cutting proves useful either on the outside perimeter or useful in vertical clearing inside the tree canopy for clearance (for power lines and such). Essentially any angle of clearing or directional shaping can be done with this of cutting method—under the canopy, on the sides, at the top, or clearing pathways through the middle without damage to the trees.

### FEDERALLY SPONSORED RESEARCH

None.

### SEQUENCE LISTING OR PROGRAM

None.

### BACKGROUND

### Field Of Invention and Prior Art

### A. Introduction of the Problems Addressed

For hundreds of years it has been a standard practice in the trimming community to make straight cut on a basically horizontal limbs and branches from trees. However, trimming in the newly conceived convex or angular cutting method has many advantages over the conventional accepted methods now in use:
Fact 1: Stafford, after trying different ways of trimming and shaping trees discovered and invented the proper way to trim and shape all trees: Convex trimming with angle cutting of tree limbs whether inside or outside of trees.
Fact 2: Stafford Tree Service developed and now performs a method to trim and shape trees unlike the world has never seen! Convex Angle Trimming. Tree limbs, shrubs, ornamental trees, horizontal and vertical growing trees. Having a surface that curves outward approximately 45 degrees in angle, making the tree come back to its natural shape no matter how out of portion the tree is now. Because of irregular growth or storm damage the tree can be brought back to its natural shape.
Fact 3: All trees heal by nature from the outside over the wound or cut. This convex angle trimming limbs on trees heal manifold, compared to conventional trimming or cutting. Conventional trimming has been done in a horizontal fashion, thus causing almost always every limb dying out and leaving/having a rotten place sets up in the canopy of the tree, causing a cavity in the tree limbs which lets water set in there and further decaying tree limbs and trunks. Simple flat cuts cannot drain off water, snow and ice and dry very well.
Fact 4: Convex angle trimming causes little or no tree damage when done right. It enhances tree limb growth and strength to tree trunks making them grow larger. Health to the tree is promoted. Trees are strengthened to survive wind storms and natural bad weather, outside or inside the tree.
Fact 5: Inside convex angle trimming clears for power lines, telephone and cable lines. You can change tree growth direction and trees safer to homeowner.
Fact 6: Stafford Tree Service is the original inventor of this true directional tree trimming and shaping process. They have perfected this improved cutting and shaping method.

### B. Prior Art

The most basic and simple methods and devices to trim trees date back several years. The historical technology focused on devices that only trimmed straight across the branches. The pruning knife patent, U.S. Pat. No. 978,574, was issued 1910 to Frumviller. In this device, the branch rested in the hook of the tool and the knife sliced the branch perpendicular to the longitudinal direction of the branch. This resulted in the flat, straight cut which did nothing to help form or encourage the tree to grow in a certain direction. Another much later device is shown by a 1981 U.S. Pat. No. 4,269,241 issued to Hickman that descried a process and apparatus for severing limbs. While the device was more complex and capable of being on a motorized vehicle, the resultant cutting was still perpendicular and did not serve to direct the tree's future growth.

Another patent for a tree trimming apparatus and method was issued as U.S. Pat. No. 5,001,858 (1991) to Frazar. It taught a plant trimming apparatus comprised of a cutting device operated in conjunction with a support apparatus. The cutting device includes an elongated handle member attached to a cutter, the cutter being preferably an electrical chain saw or tree trimmer. The handle is supported by a fulcrum apparatus which provides leverage for manipulating the cutter. The fulcrum apparatus comprises a pair of hollow tubes hingedly connected together to provide a V-shaped fulcrum point in which the handle rests. A third leg of pipe is hingedly connected to one of the legs, further down from the fulcrum point, to act as a third leg of a tripod. Another lopping tool and method for lopping invented by Schofield is shown in U.S. Pat. No. 6,345,445 (2002). It is a tool for performing lopping, pruning and similar operations and it includes a tool support, a tool head, an actuating line and an actuating handle. The tool support preferably includes a pair of telescoping tubes and the tool head includes a blade movable to perform cutting operations. The blade is coupled to the actuating line and remotely movable by tensioning the actuating line. It fails to anticipate the present device.

An apparatus for trimming and chemically treating trees in U.S. Pat. No. 6,990,770 (2006) was issued to Terrell. Here the prior art teaches an apparatus preferably coupled to a boom on a truck which can simultaneously trim and chemically treat trees or other vegetation with a herbicide. The apparatus, in addition to have a standard saw blade assembly with limb clamping jaws, includes a sprayer assembly. The sprayer assembly includes nozzles which administer herbicides or other chemical treatments adjacent to the saw blades, allowing herbicide to be precisely administered to the tree limbs as they are cut. It fails to anticipate the present device. It is extremely complex compared to Stafford's method. Another recent idea is taught by Jordan in a U.S. Patent Application 2004/0187462 called a pruning device for removing branches from living trees. It shows a pruning device for removing branches from living trees, comprising a cradle with drive means and pressure means for moving the pruning device along a tree trunk and with a sawing unit which has at least one branch saw which is arranged on the cradle in a fixed or displaceable manner. According to the invention, the branch saw is embodied in the form of a circular saw, on the periphery of which are arranged exclusively non-crossed saw teeth. It also fails to anticipate the present device.

The particular method used is unique and novel and is not anticipated by prior art. As far as known, there is no other angular or otherwise tree trimming methods to accomplish this convex pattern of tree trimming that promotes radial growth.

### SUMMARY OF THE INVENTION

A new Trimming Method for Shaping Trees called the “Convex Cutting” has been developed. It consists of essentially having method that provides a surface of the tree canopy which curves outward approximately 45 degrees in angle, making the tree come back to its natural shape no matter how out of portion the tree is now. It may be accomplished by several machines and devices. For example and not limitation, the method can be accomplished with saws (hand or power driven), pruning shears, and non-conventional limb cutting devices. A complete description is below with the Detailed Description.

The use of the Convex Cutting and Trimming Method for Shaping Trees provides concrete and substantial benefits to the business and economics of trimming through better labor use, energy, and repeatable success over other current trimming methods. Hence a new trimming process and business method is achieved.

The preferred embodiment of method or process is comprised of several steps of observation as to the tree trimming needs, the characteristics of the tree and its limbs, and a precise cutting as described below.

### OBJECTS AND ADVANTAGES

There are several objects and advantages of the new Convex Cutting and Trimming Method for Shaping Trees process and the business methods achieved with this invention. The following TABLE A summarizes various advantages and objects of the methods. This list is exemplary and not limiting to the many advantages offered by this new method.

TABLE A
Various Benefits, Advantages and Objects This device:

| ITEM | BENEFIT |
|---|---|
| 1. | May be used on various deciduous, evergreen and |
| | ornamental trees as well as shrubs and bushes. |
| 2. | Provides better limb and branch shaping than |
| | conventional horizontal cutting of trees |
| 3. | Reduces if not eliminates wound seal over that |
| | results in dead, rotten or diseased tree limbs, and |
| | hence increases the limb life and resultant overall |
| | tree-life |
| 4. | Is easy to use |
| 5. | May be used to reshape a poorly trimmed |
| | conventional method |
| 6. | Is consistent |
| 7. | Reduces labor requirements for repeated removal of |
| | dead limbs resultant from the conventional |
| | horizontal cut system |
| 8. | Harmonizes tree growth with desired shape of tree |
| 9. | Improves overall business methods in trimming by |
| | significantly increasing yield and reducing costs |
| | per tree trimmed |

Noteworthy is that other advantages and additional features of the present Convex Cutting and Trimming Method for Shaping Trees method will be more apparent from the accompanying drawings and from the full description of the device. For one skilled in the art of trimming and shaping trees, it is readily understood that the features shown in the examples with these methods are readily adapted for improvement to other types of methods for use with the tree-trimming industry in general and the cutting methods in particular.

### DESCRIPTION OF THE DRAWINGS

### Figures

The accompanying drawings, which are incorporated in and constitute a part of this specification, illustrate a preferred embodiment for the Convex Cutting and Trimming Method for Shaping Trees Method. The drawings together with the summary description given above and a detailed description given below serve to explain the principles of the method for Convex Cutting and Trimming for Shaping Trees. It is understood, however, that the method is not limited to only the precise arrangements and instrumentalities shown.

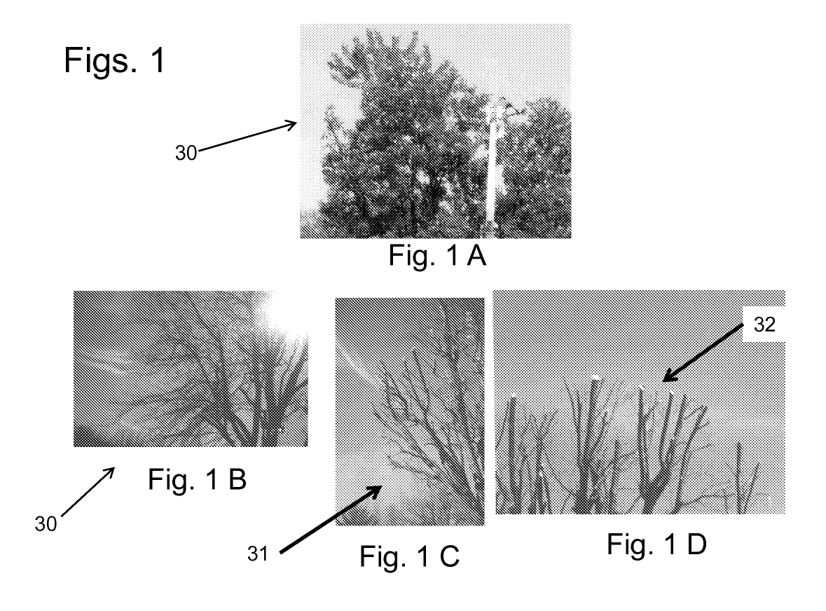

FIGS. 1 A through 1 D are photographs of the result of the trimming method and process.

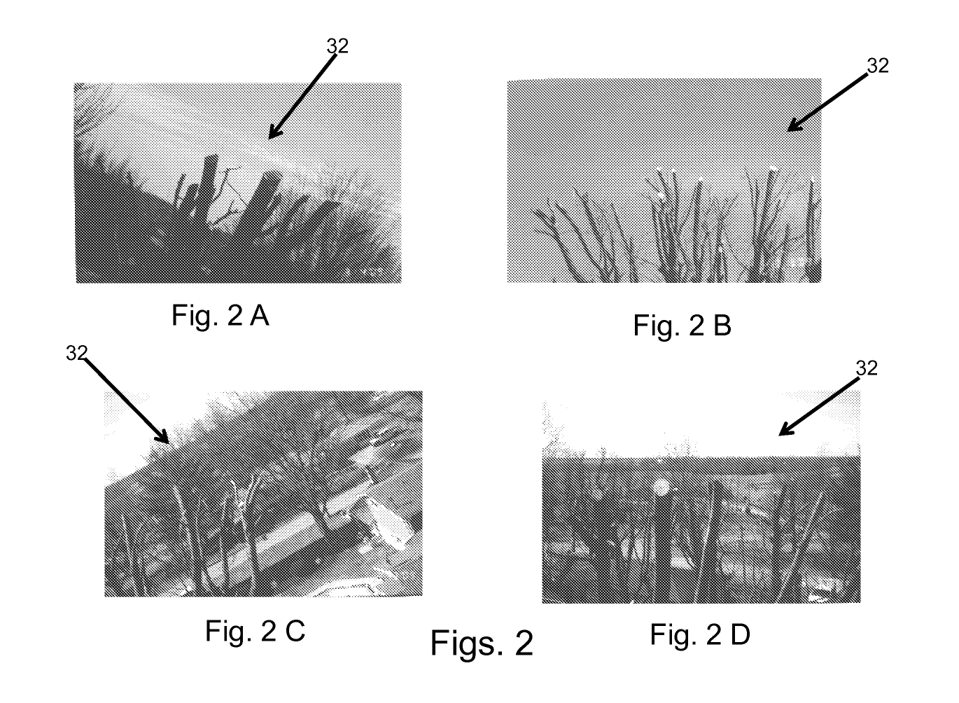

FIGS. 2 A through 2 D are up-close photographs of the result of the trimming method and process.

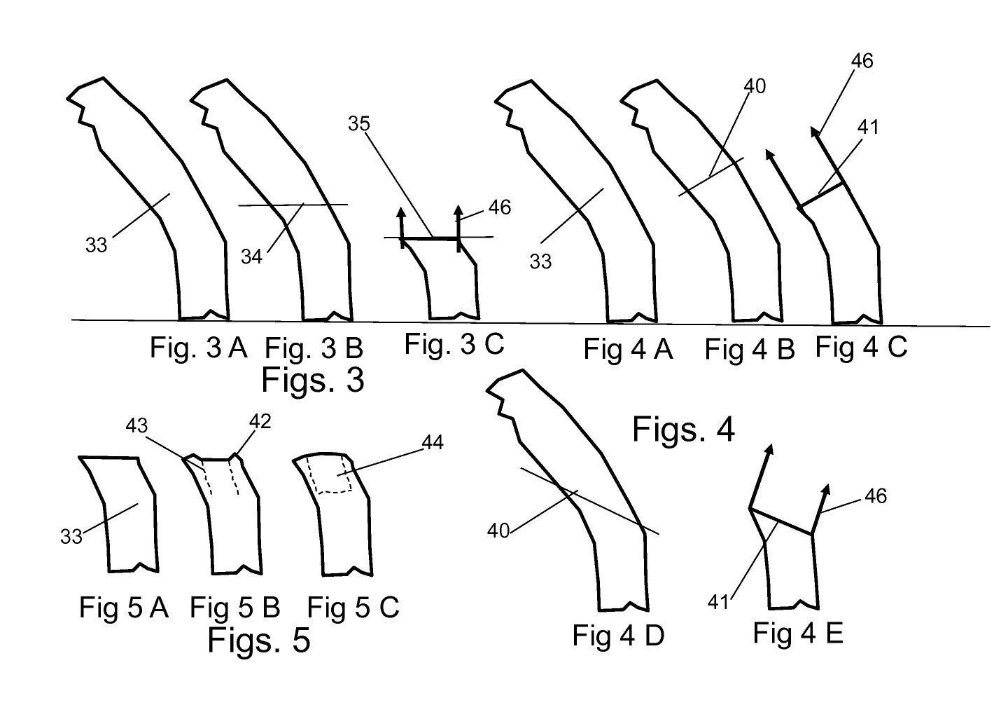

FIGS. 3 A through C are sketches of a typical copy cat horizontal cut or hack of the trim process.

FIGS. 4 A through 4 E are sketches of an improved cutting that results from the method of the angle cut method.

FIGS. 5 A through 5 C are sketches that simulate the resulting problems from a horizontal or hack copycat cut.

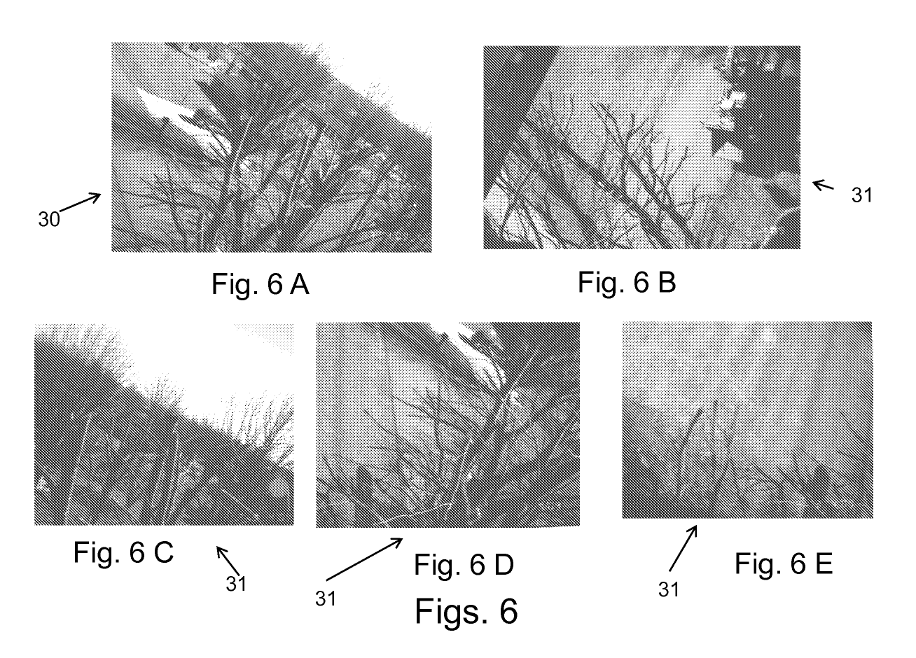

FIGS. 6 A through 6 E are additional photographs of the result of the trimming method and process.

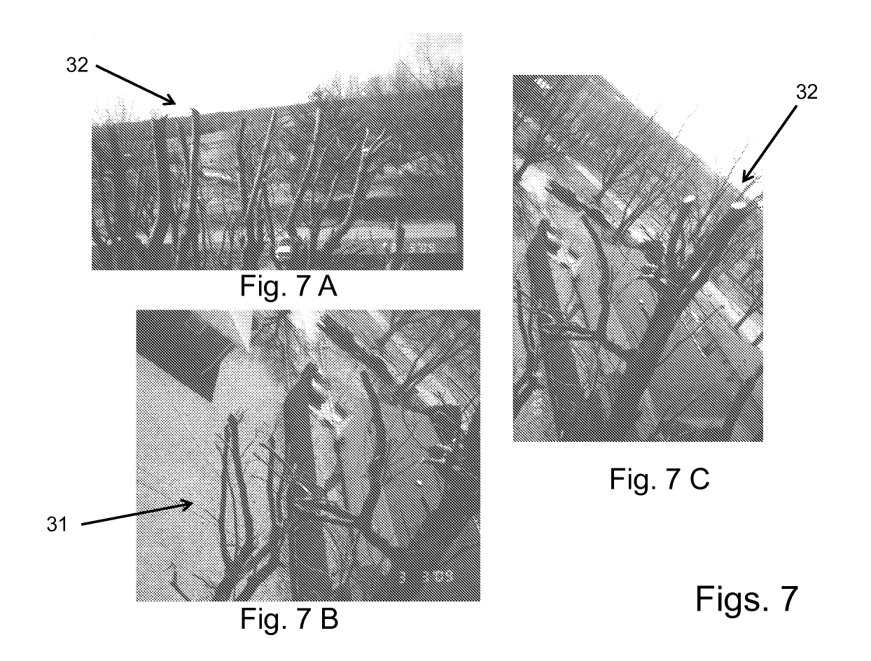

FIGS. 7 A through 7 C are more photographs of the result of the trimming method and process.

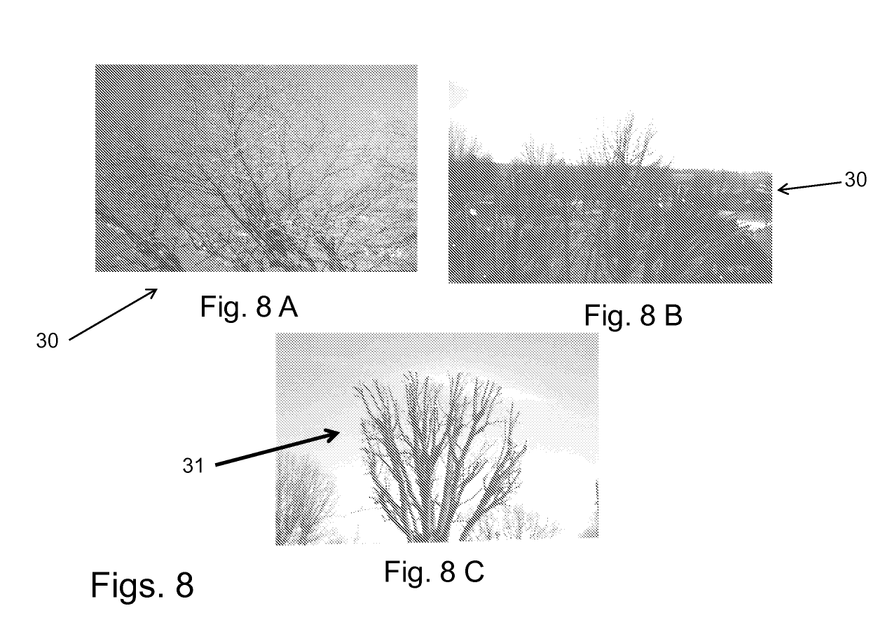

FIGS. 8 A through 8 C are additional photographs of the result of the trimming method and process.

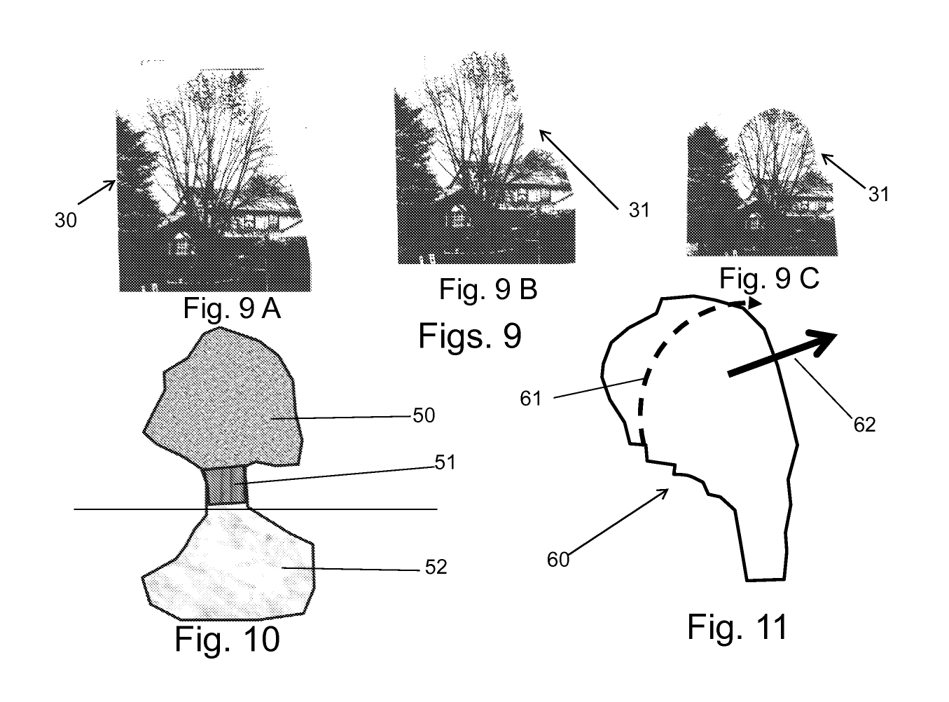

FIGS. 9 A through 9 C are additional black and white photographs of the result of the trimming method and process.

FIG. 10 is a sketch showing relationship of the canopy, tree trunk and root system.

FIG. 11 A is a sketch showing a lopsided tree and how the general radial cutting brings it back to a radial canopy.

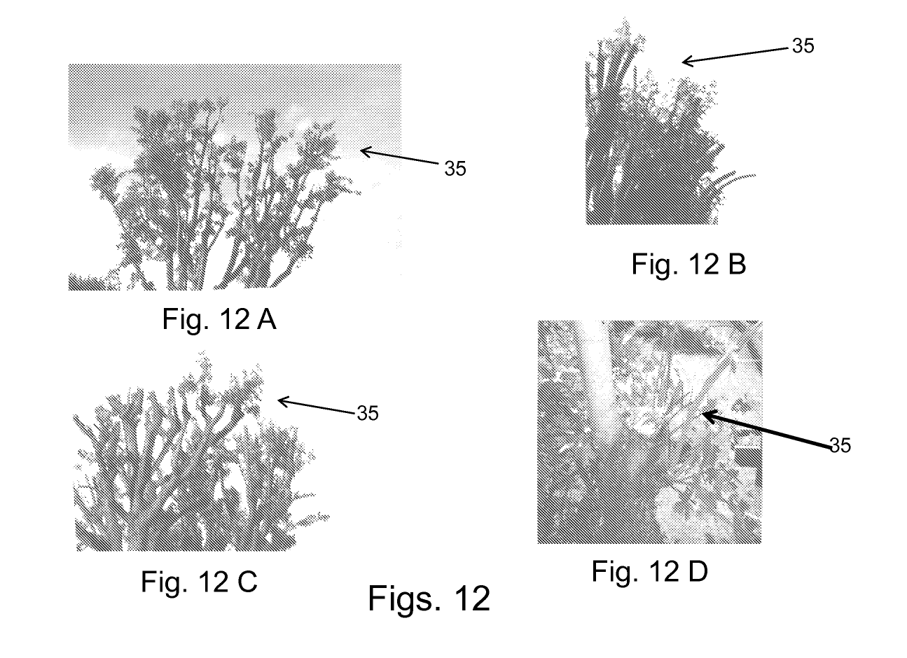

FIGS. 12 A through 12 D are photographs of the result of a copy-cat horizontal hacking method of trimming the tree.

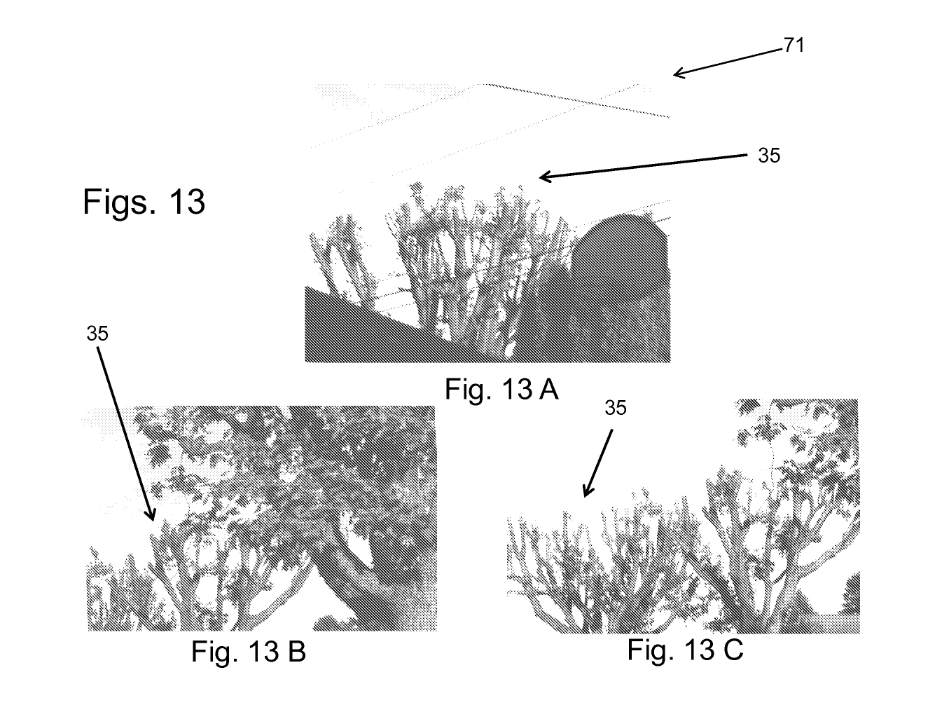

FIGS. 13 A through 13 C are additional photographs of the result of a copy-cat horizontal hacking method of trimming the tree.

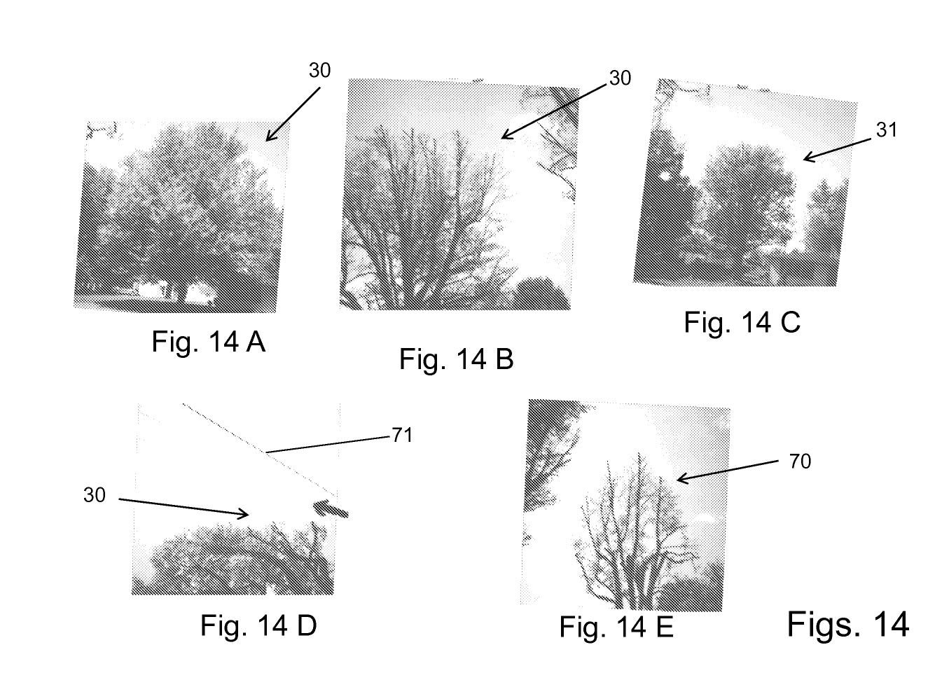

FIGS. 14 A through 14 C are photographs of the result of the trimming method and process and FIGS. 14 D through 14 E are photographs of the trimming method around power lines.

### DESCRIPTION OF THE DRAWINGS

### Reference Numerals

The following list refers to the drawings:

TABLE B
Reference numbers

| Ref # | Description |
|---|---|
| 30 | Pre-cut or trimmed tree |
| 31 | Typical Post-cut or trimmed tree |
| 32 | Close-up of angle cut tree limb after cut |
| 33 | Branch or limb to be cut or trimmed |
| 33A | Branch or limb after it is cut or trimmed |
| 34 | Horizontal cut (hack) line |
| 35 | Horizontal cut (hack) copy cat attempts |
| 40 | Line of cut angle |
| 41 | Angle cut |
| 42 | Overgrowth of horizontal cut |
| 43 | Dead or dying migration after horizontal cut (hack) |
| 44 | Dead or dying pockets or space of wood after horizontal |
| | cut (hack) |
| 46 | Growth direction - essentially perpendicular to cut line |
| 50 | Tree canopy |
| 51 | Tree trunk |
| 52 | Tree root system |
| 60 | Side growth of tree - “lopsided” |
| 61 | Direction for radial growth |
| 62 | General direction for lopsided/side growth |
| 70 | Interior limbs/growth cleared for Power line |
| 71 | Power line |
| 80 | Convex Cutting and Trimming Method for Shaping Trees |

### DETAILED DESCRIPTION OF PREFERRED EMBODIMENT

The method and process invention presented is Convex Cutting and Trimming Method for Shaping Trees. This method to a new method to increase tree survival by controlling radial growth patterns of trimmed trees. Improvements from labor, loss of trees due to poor trimming, and other savings in fuel due to less frequent trimming yield concrete financial gains in this method of doing trimming compared to typical horizontal trimming processes.

The preferred embodiment of Convex Cutting and Trimming Method for Shaping Trees 80 is comprised of several steps of observation as to the tree trimming needs, the characteristics of the tree and its limbs, and a precise cutting as described as:

| Step | Description |
|---|---|
| 1 | Observe an existing growth of vegetation and its |
| | shape |
| 2 | Determine Canopy desired |
| 3 | Determine obstructions (powerlines, buildings, etc.) |
| | to avoid with a clearance |
| 4 | View limbs and branches to determine direction of |
| | natural growth |
| 5 | Decide direction of radial growth desired (ie - |
| | perpendicular to cut plane). |
| 6 | Angle cut limbs with a means to trim in a manner where |
| | the plane of the cut is essentially perpendicular to |
| | the desired growth |
| 7 | Repeat steps as necessary |

This method results in having a surface that curves outward (in many cases) essentially 45 degrees in angle to horizon, making the tree come back to its natural shape no matter how out of portion the tree is now. The types of vegetation (for example and not limitation) growth may be bushes, shrubs, deciduous trees evergreen/non-deciduous and ornamental trees. The means to cut may be a hand or powered saw, a pruning device, a loping device, or other device for cutting vegetation.

There is shown in FIGS. 1-14 a complete detail of the results from the Convex Cutting and Trimming Method for Shaping Trees 80. In the drawings and illustrations, one notes well that the FIGS. 1 through 14 describe more of the results from using the Convex Cutting and Trimming Method for Shaping Trees

The advantages and benefits for the Convex Cutting and Trimming Method for Shaping Trees are:
May be used on various deciduous, evergreen and ornamental trees as well as shrubs and bushes.
Provides better limb and branch shaping than conventional horizontal cutting of trees
Reduces if not eliminates wound seal over that results in dead, rotten or diseased tree limbs, and hence increases the limb life and resultant overall tree-life*
Is easy to use
May be used to reshape a poorly trimmed conventional method
Is consistent
Reduces labor requirements for repeated removal of dead limbs resultant from the conventional horizontal cut system*
Harmonizes tree growth with desired shape of tree
Improves overall business methods in trimming by significantly increasing yield and reducing costs per tree trimmed
   *One skilled in the art of the tree trimming business may well appreciate that the reduced labor and the elimination or reduction of dead, rotten or diseased tree limbs increases the limb life and resultant overall tree-life. Therefore the immediate cost of performing the trimming has an improved cost. Likewise the overall lifetime cost of not replacing a tree early due to poor limb trimming will in effect reduce the cost of having the tree. This especially holds important for commercial settings around malls, parking areas and parks where a “green” effort requires so much vegetation for a given area of pavement or building improvements.

FIGS. 1 A through 1 D are photographs of the result of the trimming method and process 80. FIGS. 1 A and 1 B are tree canopies prior to cut 30. FIG. 1 C is a canopy after cut/trim 32 using the Convex Cutting and Trimming Method for Shaping Trees 80. FIG. 1 D is a close-up of the angle cut 32.

FIGS. 2 A through 2 D are additional up-close photographs of the result of the trimming method and process 32.

FIGS. 3 A through C are sketches of a typical copy cat horizontal cut or hack of the trim process 35. FIG. 3 A is the branch 33. FIG. 3 B shows the cut line 34. FIG. 3 C shows the cut 35 and the growth direction—essentially perpendicular to cut line 46.

FIGS. 4 A through 4 E are sketches of an improved cutting that results from the method of the angle cut method 80. They show the branch 33, the cut lines 40, the cut 41, and the growth direction—essentially perpendicular to cut line 46.

FIGS. 5 A through 5 C are sketches that simulate the resulting problems from a horizontal or hack copycat cut 35. FIG. 5 A is the branch after the cut 33A. FIG. 5 B is after the cut 33A with the overgrowth of horizontal cut 42 and the dead or dying migration after horizontal cut (hack) 43. FIG. 5 C is the branch after the cut 33A with the dead or diseased wood 44 in the heart of the cut branch or limb 33 A.

FIGS. 6 A through 6 E are additional photographs of the results of the trimming method and process. FIG. 6 A is the original tree canopy 30. FIGS. 6 B through 6 E are photographs after the cut 31.

FIGS. 7 A through 7 C are more photographs of the result of the trimming method and process. FIG. 7 B is a post cut photo of the Convex Cutting and Trimming Method for Shaping Trees 31. FIGS. 7 A and 7 C are close-ups of the post-cut 32.

FIGS. 8 A through 8 C are additional photographs of the result of the trimming method and process 80. FIGS. 8 A and 8 B are of the original tree canopy 30. FIG. 8 C is a photograph of the after cut 31.

FIGS. 9 A through 9 C are additional black and white photographs of the result of the trimming method and process. FIG. 9 A is the original tree canopy 30. FIGS. 9 B and 9 C are photographs after the cut 31.

FIG. 10 is a sketch showing relationship of the canopy, tree trunk and root system. The canopy 50, the tree trunk 51 and the root system 52 are shown.

FIG. 11 A is a sketch showing a lopsided tree 60 and how the general radial cutting brings it back to a radial canopy. The direction for radial growth 61 is shown with the general direction for the lopsided/side growth 62 to regain the proper canopy.

FIGS. 12 A through 12 D are several photographs of the result of a copy-cat horizontal hacking method of trimming the tree 35.

FIGS. 13 A through 13 C are additional photographs of the result of a copy-cat horizontal hacking method of trimming the tree 35.

FIGS. 14 A through 14 C are photographs of the result of the trimming method and process 80. FIGS. 14 A and 14 B are the original tree canopies 30. FIG. 14 C is a photograph after the cut 31. FIGS. 14 D through 14 E are photographs of the trimming method around power lines 71.

All of the details for the Convex Cutting and Trimming Method for Shaping Trees mentioned here are exemplary and not limiting. It is anticipated that other steps and observations may be added as a person having ordinary skill in the field of the tree trimming industry and related equipment and methods well appreciates.

### OPERATION OF THE PREFERRED EMBODIMENT

The process of Convex Cutting and Trimming Method for Shaping Trees and results are discussed above. More of the operation is discussed further below.

FIGS. 3 A through C are sketches of a typical copy cat horizontal cut or hack of the trim process 35. FIGS. 4 A through 4 E are sketches of an improved cutting that results from the method of the convex angle cut method 80.

FIG. 10 is a sketch showing relationship of the canopy, tree trunk and root system.

FIG. 11 A is a sketch showing a lopsided tree and how the general radial cutting brings it back to a radial canopy.

With the above description it is to be understood that Convex Cutting and Trimming Method for Shaping Trees is not to be limited to only the disclosed embodiments. The features of methods and devices are intended to cover various modifications and equivalent arrangements included within the spirit and scope of the descriptions.

What is claimed is:

1. A Convex Cutting and Trimming process and business method for Shaping a growth of vegetation comprised of the following steps:
(a) Observe an existing tree shape;
(b) Determine a Canopy desired;
(c) Determine any obstructions to avoid the tree growth with a clearance space;
(d) View a group of limbs and branches of a to determine direction of natural growth;
(e) Decide direction of radial growth desired which is perpendicular to cut plane;
(f) Angle cut limbs with a means for cutting tree limbs in a manner where the plane of the cut is perpendicular to the desired growth; and
(g) Repeat steps as necessary
wherein the special method may be used to trim and cut trees to a desired shape and significantly reduce the cost of trimming.

2. The method according to claim 1 wherein the types of vegetation growth is a deciduous tree.

3. The method according to claim 1 wherein the types of vegetation growth is a non-deciduous tree.

4. The method according to claim 1 wherein the types of vegetation growth is a ornamental tree.

5. The method according to claim 1 wherein the types of vegetation growth is a shrub.

6. The method according to claim 1 wherein the means to cut is a saw.

7. The method according to claim 1 wherein the means to cut is a pruning device.

8. The method according to claim 1 wherein the means to cut is a loping device.

9. The method according to claim 1 wherein the means to cut is a powered device.

10. A Convex Cutting and Trimming process and business method for Shaping a growth of vegetation comprised of the following steps:
(a) Observe an existing tree shape;
(b) Determine a Canopy desired;
(c) Determine any obstructions to avoid the tree growth with a clearance space;
(d) View a group of limbs and branches of a to determine direction of natural growth;
(e) Decide direction of radial growth desired which is perpendicular to cut plane;
(f) Angle cut limbs with a means for cutting tree limbs in a manner where the plane of the cut is perpendicular to the desired growth; and
(g) Repeat steps as necessary
wherein the special method may be used to trim and cut trees to a desired shape and the method significantly increases yield and reduces costs per tree trimmed.
